(19) United States
(12) Patent Application Publication
(10) Pub. No.: US 2005/0125453 A1
(43) Pub. Date: Jun. 9, 2005

(54) Method and apparatus for webcast launch

(76) Inventor: Mike Rozack, Cleveland, OH (US)

Correspondence Address: BAKER & HOSTETLER LLP;Washington Square, Suite 1100, 1050 Connecticut Avenue, N.W., Washington, DC, 20036, US

(21) Appl. No.: 10/976,776

(22) Filed: Nov. 1, 2004

Related U.S. Application Data
(60) Provisional application No. 60/515,668, filed on Oct. 31, 2003.

(51) Int. Cl. G06F 7/00

(52) U.S. Cl. 707/104.1

(57) ABSTRACT

A mechanism and method of delivering streaming content with a minimal or only a single line of code in the client's website is provided. The code, i.e., “LaunchCode,” enables users to deliver their webcasts directly from their site—the webcast displays in a “new” window, so that viewers do not have to leave the client's site. LaunchCode handles the proper delivery of content throughout the “webcast lifecycle” such that the client does not need to make any modification to their site once the code is in place. Implementation of this system minimizes the webcast management responsibilities of a client.

### CROSS-REFERENCE TO RELATED APPLICATIONS

This application claims priority to provisional U.S. patent application entitled, “WEBCAST LAUNCH CODE,” filed Oct. 31, 2003, by the present inventor having Ser. No. 60/515,668, the disclosure of which is hereby incorporated by reference in its entirety.

### FIELD OF THE INVENTION

The present invention relates generally to streaming audio and video from a website. More particularly, the present invention relates to the virtual streaming of audio and video from any website, by implementation of a minimal amount of code and minimal stream management on the viewed website.

### BACKGROUND OF THE INVENTION

Conventional streaming of audio and video from a website is referred to, commonly, in the internet community as a webcast. Webcasting, though principally applied to streaming audio and video, can be applied to streaming data and other services, as provided by the website. Conventional webcasting requires the content to be hosted on a website that the viewer is visiting. The user would simply click on a link on the website to connect to the hosted content. Despite the apparent ease of this approach, webcast files are typically very large and require an assortment of administrative controls to permit a structured delivery of the webcast content as well as add-ons, thereof to users.

Accordingly, conventional webcasting requires a webcaster to host, service, administrate, manage delivery of the webcast content on their servers to users visiting their website. Of course, this entails a significant amount of data storage and overhead for a webcast provider.

It would be, therefore, desirable for systems and methods that enable the convenient delivery of webcast content to a user without requiring the webcaster to commit the significant resources necessary for a webcast.

### SUMMARY OF THE INVENTION

The foregoing needs are met, to a great extent, by the present invention, wherein in one aspect an method is provided that in some embodiments provide webcasting over a communication network, comprising the steps of, generating a client-side website code, wherein the code links to a remote webcast server having webcast content, dynamically generating a window by executing on a client-side server, code hosted on the webcast server, and webcasting the webcast content through the dynamically generated window.

In accordance with another embodiment of the present invention, a method of webcasting over a communication network, is provided, comprising the steps of, updating a status of a scheduled webcast on a client-side website, generating a client-side website code, wherein the code links to a remote webcast server having a content of the scheduled webcast, dynamically generating a window by executing on a client-side server, code hosted on the webcast server, and webcasting the webcast content through the dynamically generated window.

In accordance with another embodiment of the present invention, a system for webcasting over a communication network, is provided, comprising, a server hosting a client's webpage, the server connected to a communication network, a launchcode inserted into the client's webpage, the launchcode having a reference to a webcast server's dynamic programming script and a webcast content identifier, a launchcode link on the client's webpage, and a webcast server, the webcast server being connected to the communication network and having the dynamic programming script and the webcast content identified by the webcast content identifier.

In accordance with yet another embodiment of the present invention, a system for webcasting over a communication network, is provided, comprising, an internet service provider connected to a communication network, a server hosting a client's webpage, the server being connected to the communication network, a launchcode inserted into the client's webpage, the launchcode having a reference to a webcast server's dynamic programming script and a webcast content identifier, a launchcode link on the client's webpage, and a webcast server, the webcast server being connected to the communication network and having the dynamic programming script and the webcast content identified by the webcast content identifier.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an illustration of a sample conventional website.

FIG. 2 is an illustration of a conventional website modified with an exemplary embodiment of the invention.

FIG. 3 is an illustration of an exemplary webcast player window.

FIG. 4 is an illustration of an exemplary webcast window with a countdown feature.

FIG. 5 is an illustration of a website with an exemplary registration feature.

FIG. 6 is an illustration of a website with a standby message.

FIG. 7 is an illustration of a website modified with another exemplary embodiment.

FIG. 8 is a flow chart illustrating an exemplary process.

FIG. 9 is a block diagram illustrating an exemplary system implementation.

### DETAILED DESCRIPTION

The invention will now be described with reference to the drawing figures, in which like reference numerals refer to like parts throughout. An embodiment in accordance with the present invention provides systems and methods for controlling delivery of a webcast on a remote website by providing the website operator a minimal amount of code, the code having parameters that can be set by the website operator, or receiving from the website a request to deliver a webcast, or determining the status of the webcast, or generating appropriate code based on a status, or displaying the code with the adjustments from the operator.

For the sake of this description, terms like “watch”, “see” or “view” will be used to describe webcast content, although said content may be video-based or audio-based or a combination of the two.

Broadly speaking, webcasts can be divided into two types: on-demand, that is, content which the viewer can watch at anytime, and live, that is, content which the viewer must watch at a specific time. It is very common to find on-demand content that was once live content, and live content that is often made available afterwards for on-demand viewing.

In conventional systems, the most basic way to deliver an on-demand webcast from one's website is to put the file onto a webserver, and use an ordinary HTML “hyperlink” to the file. For example:

<a href=http://www.xyz.abc/mywebcast.asf>click here</a>

There are several effects and limitations of using such a link. First, the file (“mywebcast.asf” ) is not delivered to the viewer using true “streaming” (i.e. with streaming, the data is received in small parts and the user can watch/listen immediately, but nothing is actually downloaded to the user's computer), but rather, the file is actually copied to the user's computer. Depending on the configuration and bandwidth connection of the user's computer, the user may have to wait until the entire file is downloaded before he can view/hear any part of the webcast. This can create bandwidth problems for both the user and the provider. Specifically, if the user is on a slow connection, he may have to wait for a long time, and for the provider, if multiple users with fast connections attempt to access the file, the provider's server may not be able to keep up with this task. Additionally, using such a link does not allow the user to selectively access portions of the webcast—the user is forced to download the entire file, regardless of what part he actually wants to see/hear. Also, any interactive elements (e.g., slide shows, table of contents, etc.) may not function. And finally, this type of link will only handle “on-demand” content; it will not accommodate “live” broadcasts.

An alternative to the above-described hyperlink approach is to place the content on a video server (as opposed to a webserver), which is specifically designed to deliver streaming content. For example, for an On-Demand or Live webcast, the following code can be used:

On-Demand:
<a href=mms://server.abc/mywebcast.asf>click here</a>
Or
<a href=”rtsp://server.abc/mywebcast.ram”>click here</a>
Live:
<a href=mms://server.abc/live>click here</a>
Or
<a href=”rtsp://server.abc/live.rm”>click here</a>

It should be noted, that while it appears that by simply changing the pre-fix of the first example from “http” to “rtsp,” accomplishes the same result, this does not make the content stream correctly. At least a video server is needed, as video servers are specially designed for streaming delivery.

While placing the content onto a video server and providing an ordinary link may be acceptable, it also has several flaws, such as: (1) reliance on the user/browser to understand how to utilize the file being delivered; (2) assumes the user has already installed an appropriate “helper” application or “plug-in” (or “player”, hereinafter) to display file; (3) the file will be displayed using whatever player user has configured, which may not be most appropriate (or may not even work); (4) delivery using the “default” player may provide for unrelated content to be displayed alongside the intended content; (5) no or very little control over appearance of the content in player; (6) the user can be easily distracted by unrelated content; (7) often appears unprofessional, not appropriate to have “popular music” with “business content”; (8) uncontrolled appearance—no ability for branding or supplemental content; and (9) for live content (or on-demand content that is to be made available during a certain time-frame), access can be problematic. As is apparent, this approach can be replete with difficulties.

Another approach for webcasting is in the form of an “embedded” player that appears to be part of a webpage. This delivery method solves some problems, such as controlling appearance and helping to ensure that the appropriate player is available and used, but there are still flaws related to the delivery of live (or otherwise timed-based) content. Also, delivering dynamic and synchronized supplemental content via this method can be difficult, or impossible.

Another approach, which is a variation on the above embedded player, is to place the webpage with the embedded player into a “frameset,” a webpage technology that allows multiple pages to appear together in a single browser window. Advancing on this idea, one can open a separate window, sized to a specific width and height, which then contains the frameset (which contains a webpage with an embedded player). By removing the borders between each frame, it appears to be one single webpage.

However, to enable such a display requires an advanced understanding of web programming languages, and the content creator must build and maintain multiple webpages to accommodate the various “stages” of the webcast (as discussed previously). Also, the original webpage which contains the link to the frameset must be modified each time the webcast “stage” changes. For example, after a live webcast ends, it would be undesirable to allow viewers to access a “broken” page, i.e., one that contains an embedded player to a webcast that is not longer being streamed.

Another common (and of lesser quality) technique for providing access to webcast content is to create a so-called “landing” page—which is simply a webpage that contains a link of one of the above-referenced types. The primary disadvantage of using a landing page is that the viewer must “leave” the client's website to view the webcast. This is comparable to eating at a restaurant that makes you walk across the street to see the menu. Even if a landing page is designed to look similar to the originating website, there are frequent visual and functional differences—which can confuse or dissuade the viewer. And maintaining a landing page can be tedious and error-prone, especially when the design of the originating site changes.

In all the above cases, it is common practice to provide multiple user links to a single webcast, such that the viewer is required to select the most “appropriate” streaming content for their system, based on the user's bandwidth. For example, a provider may make two versions of a webcast—one for dial-up modem users (with a lower bitrate, fewer frames, etc.), and one for users with higher-speed Internet access (with a higher resolution, better audio, etc.). This technique, while used frequently, assumes that the user knows which link is the best one for them to use.

In view of the deficiencies described above, the invention provides a convenient mechanism(s) for addressing many of the problems of the prior art. In various exemplary embodiments, delivery of streaming content (and related materials) with a minimal or often only a single line of code in the client's website is all that is required by the client. In general, code, referred to hereinafter as “LaunchCode,” enables users to deliver their webcasts directly from their site -the webcast displays in a “new” window, so that viewers do not have to leave the client's site. LaunchCode handles the proper delivery of content throughout the “webcast lifecycle” such that the client does not need to make any modification to their site once the code is in place. These and various other features of this invention are described in further detail below.

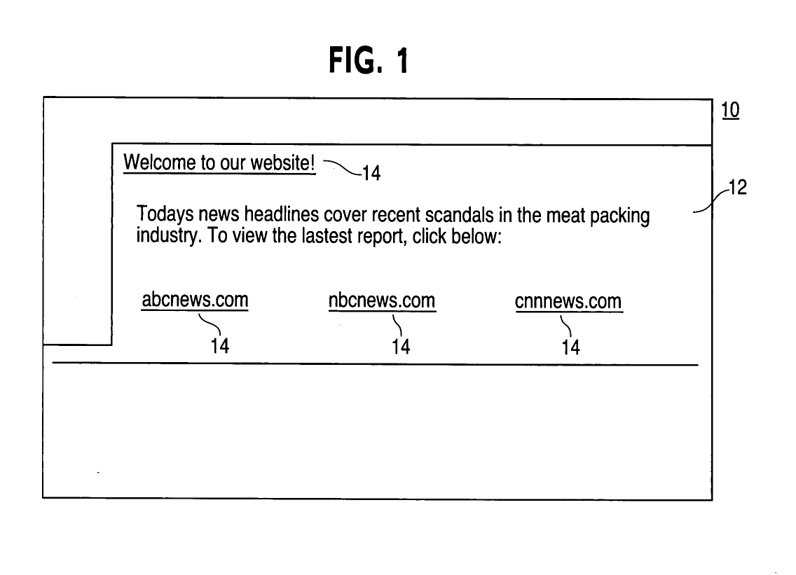

FIG. 1 is an illustration of a sample conventional website 10. the conventional website 10 can have any one or more of graphics or text 12 for conveying information to the website viewer. As is well known, hyperlinks are conventionally noted with an underline 14. The website 10 may be viewed by any browser or viewing application, as deemed appropriate. Since the appearance, design and layout of conventional websites are well known in the art, elaboration of the attributes of conventional websites attributes is foregoed.

In operation, the conventional website 10 features several hyperlinks directing a viewer to related articles hosted on the website server or hosted on a non-local server. For example, the hyperlink for “abcnews.com” may contain a URL for an “ABC News” server. Therefore, as discussed above in the “Background of the Invention”, the conventional website 10 may direct or facilitate webcasting in accordance with known conventional methods, with their attendant deficiencies.

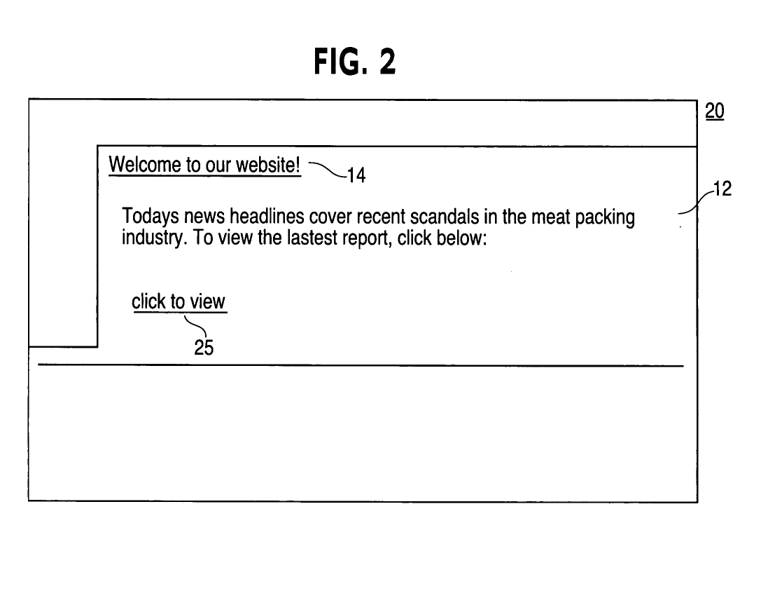

FIG. 2 is an illustration of the website 20 with an exemplary embodiment of the invention. The website 20 is many respects similar to the website 10 of FIG. 1. However, the webcast links are replaced with a specialized LaunchCode link 25, annotated in the website 20 as “click to view”.

Of course, it should be appreciated that while FIG. 2 illustrates the LaunchCode link 25 as a text link annotated with “click to view”, other available text or non-text representations can be used. For example, graphics, macromedia, shockwave, avatars, etc. maybe used to direct the viewer to initiate the LaunchCode link 25.

In the exemplary embodiment of FIG. 2, the LaunchCode link 25 is generated by placing the following code in the website 20 source page:

<script language=”javascript”
src=http://www.webcastgroup.com/launch.code?wid=0123456789>
</script>

This line of code is similar in appearance to other JavaScript code placements. In fact, to the client placing the code on their site, it appears to an outside user to function as such. However, a significant difference in this over typical JavaScript code implementation is the “launch.code” in the “src” parameter (i.e., source code parameter). Typically, the “src” parameter is used to indicate a JavaScript file, have a file extension “.js”. However, on the webcasting server, the “.code” file extension is configured not to JavaScript, but to Active Server Pages (ASP), which provide dynamic web page creation and management control.

Since the user is viewing the website 20 remotely from the client's servers, and control of the website 20 using simple JavaScript results in a static or hard to maintain client-managed system, a mechanism for remotely and dynamically controlling the client-side server website 20 is needed. Herein, the substitution of dynamic web page creation and control, using ASP or other dynamic Web programming languages or systems, such as, for example, PHP or Cold Fusion, etc., can be used to produce the requisite amount of control and clientless management of the website 20.

In this exemplary embodiment, for the “launch.code” file, the content-type is set to JavaScript so that the resulting page that is generated is “understood” by the client browser to be a JavaScript file. Then, the “wid” value, which is the webcast id, is used to gather the appropriate data for this webcast from a SQL database. (Based on the “wid” value, different webcasts can be selected.) Then, the necessary code is “written” to the screen, in a format that the browser or viewing application will then interpret as JavaScript code, which the browser will execute per World Wide Web Consortium (W3C) standards,

For example, in this sequence of ASP code: Response.Write (“document.write (‘click to view’)”), will cause the following text to be written to the browser as JavaScript: document.write (‘click to view’),which the browser will interpret to cause the following text to be written to the screen as ordinary HTML “click to view”. Based on a combination of these programming methods, the viewed website can be virtually represented and simply maintained by the webcast server without affecting the client's server. Further discussions of an implementation of the exemplary embodiments using, for example, ASP language is detailed below.

In view of the above, it should be appreciated that implementing LaunchCode can simply involves a copy and paste modification on the client's website. Therefore, whether the client is a technically advanced webmaster or computer novice, the client can quickly understand the reasons for using LaunchCode.

Based on an exemplary implementation, as described above, the LaunchCode link 25 is activated by the user's clicking or invoking a callback operation on the link 25, whereby a new window for webcasting is displayed, as further discussed below.

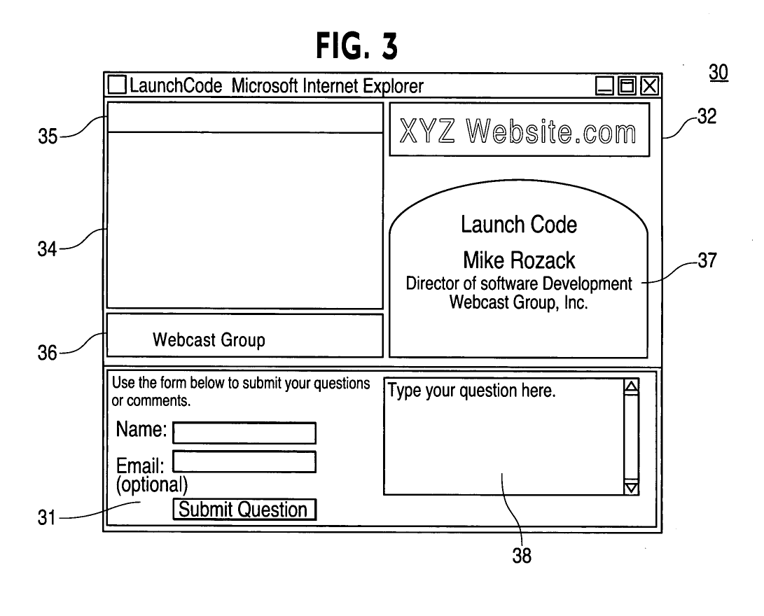

FIG. 3 is an illustration of an exemplary webcast player window 30, invoked from the LaunchCode link 25, having a native or customized frame. In the exemplary embodiment of FIG. 3, the native window is illustrated as a Microsoft Internet Explorer window 32 having the Microsoft frame attributes therein. The window 30 contains one or more menus or interfaces with the user. For example, the window 30 contains a video frame 34 having video controls 36. The viewing frame 34 is shown with a status indicator 35 with the text “loading . . . ” to indicate that the webcast is not ready, but loading.

Other frames (in some programming paradigms, the frames are referred to as windows and, therefore, the nomenclatures are interchangeable used) or windows such as an identification frame 39 and comment/question frame 38 can be included in the webcast window 30. Of course, it should be appreciated that additional or less frames having different functions and capabilities maybe implemented according to design preference. For example, the informational frame 37, though appearing as a static frame, may have graphics, animation, advertisements, other forms of interaction as desired. Also, though not illustrated in FIG. 3, it is possible to have multiple respective frames or windows as well as different arrangements with features therein. For example, a chat room-like window maybe provided to enable interactivity, such as in the context of a webcast having pedagogical attributes.

Moreover, it should appreciated to one of ordinary skill in the art of graphical user interface (GUI) paradigms, alternative features such as, for example, radio buttons, sliding bars, toggle, etc., widgets and interfaces maybe implemented according to design preference. Thus, it should be appreciated that various modifications to the webcast window 30 and other exemplary embodiments described herein may be implemented without departing from the spirit and scope of this invention.

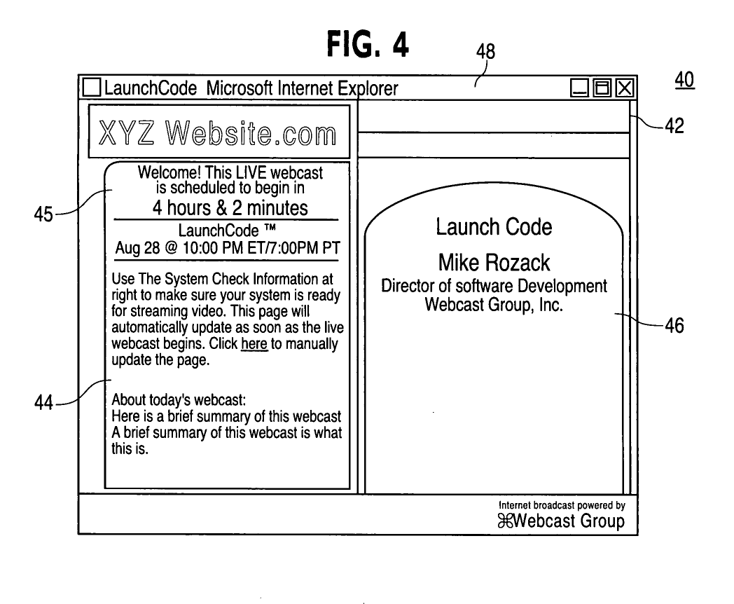

FIG. 4 is an illustration of exemplary webcast window 40 with a countdown feature. The exemplary webcast window 40 is invoked prior to the start of an actual webcast. The exemplary window 40, as illustrated, for example, as being contained in an Microsoft Internet Explorer frame 42. Within the frame 42 attendant features such as communication, email controls, status, etc. 48 is provided. A countdown indicator or timer 45 is provided within the exemplary webcast window 40. Text 44 and/or graphics 46 maybe implemented as desired. It should be appreciated that while FIG. 4 illustrates a combination of the above-described elements, more or less graphical user interface (GUI) elements maybe implemented in according to design preference. For example, registration features or chat room features or communication/informational features maybe implemented without departing from the sprit and scope of this invention.

In operation, the exemplary webcast countdown window 40 will transition to a webcast player window such as, for example, described in FIG. 3, upon arrival of the designated webcast playing time. As is apparent, the countdown window 40 provides helpful information to the viewer, such as the description of the webcast and other pertinent information. Moreover, the countdown window 40 lets the viewer know if their computer is capable of displaying the webcast (e.g., text 44). Other capabilities of the countdown window 40 may include an evaluation of viewer's bandwidth to determine which is the appropriate streaming content for dissemination to the viewer.

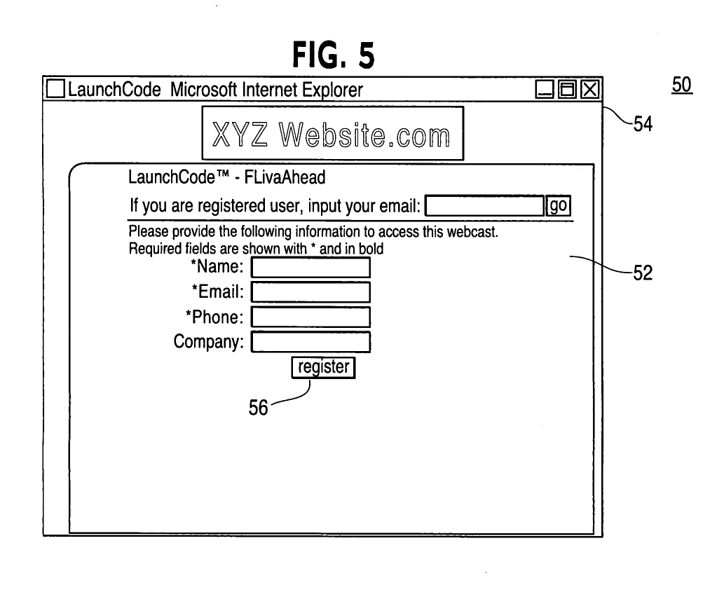

FIG. 5 is an illustration of a website 50 with an exemplary registration feature. The website 50 is invoked from a LaunchCode which invokes a preliminary registration form 52. The registration form 52 is handled, for example, within a Microsoft Internet Explorer frame 54. The registration form 52 operates to “register” new users or returning users. Upon the inputting of the solicited “registration” information, the user clicks the register button 56 to proceed to a webcast player window, such as, for example, discussed in FIG. 3, above. While FIG. 5 illustrates a registration form 52 having the data field: email, name, phone, and company, it should be appreciated that alternative data fields maybe used, according to design preference. For example, rather than using email to provide access to returning users, a user name and/or access code or a password maybe facilitated. Additionally, cookies, where appropriate, maybe implemented to bypass the registration procedure for returning users. As such, error dialog or login-like procedures maybe used where appropriate. In operation, as the user clicks on a LaunchCode with a registration window attribute, a registration window will be invoked, if registration or controlled access to the webcast is desired. After successful registration or “logging in,” the user can be directed an exemplary webcast player window such as, for example, described in FIG. 3.

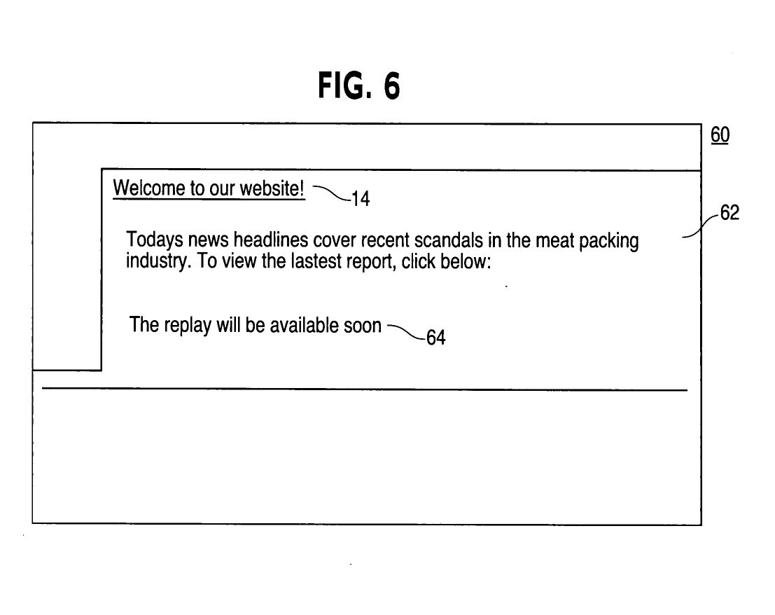

FIG. 6 is an illustration of a website 60 having the unavailable replay of a webcast indicated to the user with the text “the replay will be available soon” 64. FIG. 6 encompasses a scenario where after a “live” or “on-demand” webcast has been made, resources for replay of the webcast are not immediately available. Of course, other indicators instead of the text 64 may be used, as desired. It should be appreciated that the unavailability message of FIG. 6 may also be supplemented with the countdown timer or date of availability, or other desired communication to a website viewer.

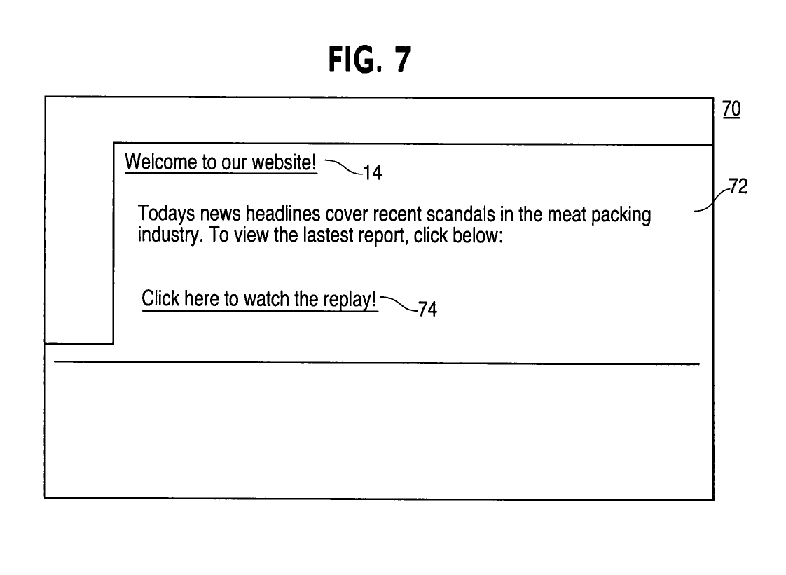

FIG. 7 is an illustration of a website 70 with another exemplary embodiment having a similar configuration to that described in FIG. 2. However, the LaunchCode link 74 is designated for watching a replay rather than a live webcast. The exemplary website 70 maybe implemented subsequent to the website 60 of FIG. 6. That is, during the period that replay is not available, the client's website can post an image similar to that described in FIG. 6. Subsequent to availability of the replay, the client's website can replace the posted image with that of the website 70 image of FIG. 7.

In operation, as the replay feature becomes available, as indicated by the replay text 74, the user, upon activation of the LaunchCode, can be directed to an exemplary webcast window such as, for example, shown in FIGS. 3-5.

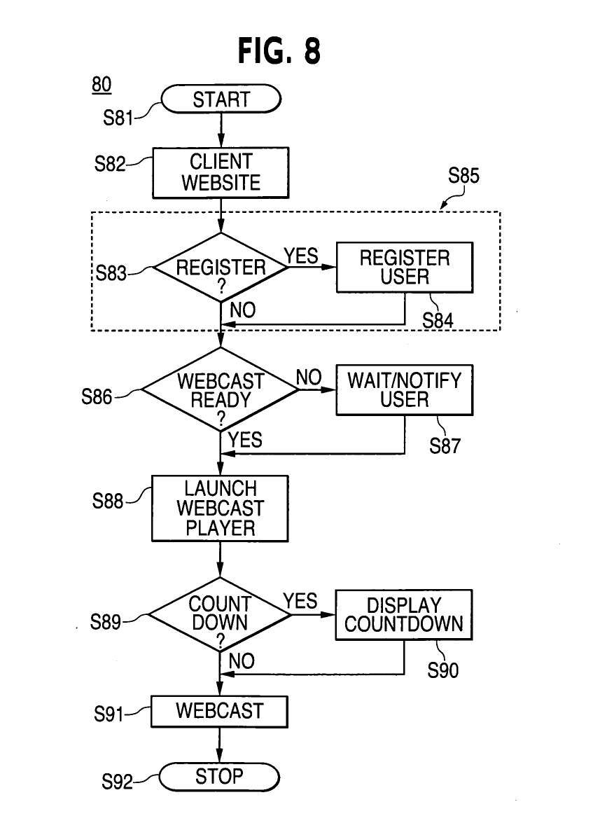

FIG. 8 is a flow chart illustrating an exemplary process 80 made possible by the implementation of the exemplary LaunchCode. The exemplary process 80 starts at a step S81, to proceed to step S82 where the user (not shown) is presented with a website hosting the LaunchCode. It should be appreciated that the website may be hosted on the client-side by a server or any other suitable system capable of supporting a website on the internet. In step S82, the LaunchCode in the website is activated by the user's selection of the hyperlink, which forwards the user to the optional step S85, containing steps S83 and S84. Optional step S85 is invoked if the client's website is configured for a registration or controlled access. If so configured, then the user is prompted with a registration form S83 whereby the user is prohibited from proceeding further in the exemplary process 80 until registration is complete. Login windows, as well as error windows, or other typical access control schemes may be used according to design preference to facilitate the user's access to the webcast. If registration is properly completed, as indicated in step S84, then the exemplary process 80 proceeds to step S86 to initiate the webcast status inquiry.

If the exemplary process 80 is not configured for registration, then rather than proceeding along the optional step S85, the exemplary process 80 jumps from step S82 to step S86. Notwithstanding the approach taken to arrive at step S86, the exemplary process 80 evaluates the status of the webcast to determine if webcasting can begin. For example, if a replay scenario is being invoked by the exemplary process 80, a determination of the resources and availability of the replay is investigated. If the resources for a replay are available, then the exemplary process 80 proceeds to step S88 to begin the webcast launch. However, if the resources for the replay are not available, then the exemplary process 80 proceeds to step S87 to await availability. At step S87, the user may be notified of the fact that replay is not available, or a countdown window showing the amount of time or the date upon which replay will be available maybe presented to the user. Of course, it should be appreciated that while the above discussion is framed in the context of a “replay,” the above steps are equally applicable to a live webcast or on-demand webcast.

From step S88, the exemplary process 80 determines if a countdown window/indicator is necessary prior to beginning the webcast. The countdown, as indicated in step S90, can also be used when the user has “logged on” prior to the designated time/date for a live-webcast, or a scheduled webcast. In such instances, the countdown step S90 informs the user that the webcast will begin at the designated time/date. From step S90, upon arrival of the appropriate time or condition, the exemplary process 80 proceeds to step S91, to begin the actual webcasting.

In step S89 above, if it is determined that a countdown is not necessary, the exemplary process 80 jumps to step S91 to begin the webcast. Upon the initiation of the webcast at step S91, a window or frame according any of the exemplary embodiments described herein may be used to provide the user a webcasting experience. Within step S91 or step S85, statistics on the number, type, characteristic, etc., of the users viewing the webcast can be tabulated for metrics regarding the webcast audience, etc. From step S91, upon completion of the webcast, or by choice of the user, the exemplary process 80 terminates at step S92.

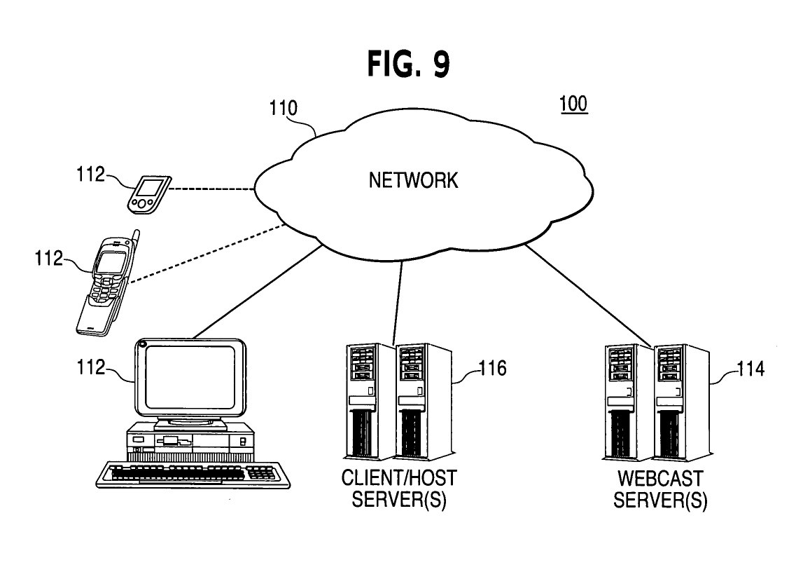

FIG. 9 is a block diagram illustrating an exemplary system implementation 100 utilizing a communication network 110 to exchange or transfer data/commands to user devices 112. The network 110 can be any communication network, including the Internet, LAN, wireless, Ethernet, etc. that enables communication to the user devices 112. The user's devices 112 are illustrated in FIG. 9 as comprising a wireless Palm/PDA device, or a mobile phone or a wired computer. However, as should be appreciated, the user device(s) 112 can be any device capable of viewing a webcast and may comprise other now-known or future devised systems for viewing a communicated webcast, as well as any wired or non-wired mechanism for communicating to the user devices 112.

The user device(s) 112 receive webcasts from a webcast server(s) 114 which are connected to the network 110. The webcast servers 114, in the preferred embodiments are video servers, but other servers, whether specialized video servers or non-video servers, may be used, according to the configurations designated therein. For example, the resolution of a user's mobile phone 12 may be low enough to enable webcasting with a conventional server. Accordingly, a hybrid of non-video and video servers 114 may be used for webcasting. Additionally, while FIG. 9 illustrates two webcast servers, less servers may used as well as additional servers, depending on the demand of services provided to the user.

Webcasting of the webcast data/video/audio content from the webcast servers 114 to the user device(s) 112 is initiated by a user “surfing” to the client's servers 116 and invoking a LaunchCode, as described herein. By invoking the LaunchCode, hosted on the client's website (either on the client's server or remotely on another non-client server—i.e., remote-hosting), an exemplary webcast window/process as described herein is initiated. While FIG. 9 illustrates two client/host servers 116, less or additional servers may be used, according to design preference.

Implementation of the above-described processes and systems are facilitated by the use of software code. Examples of the software code for the various exemplary embodiments of LaunchCode and related operations are demonstrated below.

For dynamic (client-side) code using dynamic (server-side) code:

```
<html>
<head>
<title></title>
</head>
<body>
<script language=”javascript”>
<%
If WebcastStatus = “Coming soon” Then
Response.Write(“document.write(‘coming soon’)”)
Else
    If WebcastStatus = “Live” Then
        Response.Write(“document. write(‘”)
        Response.Write(“<a href\’pagel.html\’>”)
        Response.Write(“click to watch live”)
        Response.Write(“<Va>”)
        Response.Write(“’)”)
Else
        Response.Write(“document. write(“)
        Response.Write(“<a href\’page2.html\’>”)
        Response.Write(“click to watch the replay”)
        Response.Write(“<Va>”)
        Response. Write(“’)”)
    End If
End If
%>
</script>
</body>
</html>
```

When placed on a server capable of serving dynamic webpages, and then viewed in a browser, the viewer will see one of three things, depending on the value of “WebcastStatus.” If the webcast is “coming soon”, the viewer will see a linkless message:
coming soon
   If the webcast is “live”, the viewer will see a linked message:
click to watch live
   Which, when clicked, will link to “page1.html”. If the webcast is neither “coming soon” nor “live”, the viewer will see a linked message:
click to watch the replay
   Which, when clicked, will link to “page 2.html”.

To enable the user/viewer to remain at the client's website, standard links are not provided. Rather, the above links are to new windows having client-side specific attributes (e.g., size and scrollbars). To accomplish this, JavaScript is employed. For example, instead of the typical HMTL code:<a href=“page.html”>click to watch</a>, the following is used:
<a href=“#” onclick=”return fncOpen( )”>click to watch</a>

Where “fncOpen” is a (client-side) JavaScript function that can be pseudo-coded as:

```
function fncOpen( ) {
    var url = “page.html”
    var name = “page”
    var param = “width=300, height=350, location=0, status=0”
    var w = window.open(url, name, param)
    return false
}
```

By the use of the above coding paradigm, when the user/viewer clicks on the link, a new window is opened on the user/viewer's computer from the client-server with the client's desired attributes.

However, in the above first example, everything between “<%” and “%>” must be “served” from the webcasting server, and not the client-server, as the code block pertains to information/status of the webcast from the webcasting server. One approach to enabling server-side code on a remote website is to create a JavaScript file that contains much of the above code, and instruct the client on how to use it, as shown above. However, this would require a “hard-coding” portions of the data, which would entail tracking of updates and re-instructing the client upon each update.

To avoid this difficulty, a client-side JavaScript code is dynamically generated, using server-side code. Specifically, instead of using an “external.js” (JavaScript) file having ordinary JavaScript code, an “extemal.asp” (Active Server Page) file is used, which generates dynamically server-side code on a remote website. Any dynamic server-side programming language and environment, such as PHP, JSP, etc. would be acceptable. The “external.asp” page functions as:

```
<%
Response.ContentType = “application/x-javascript”
Qry = “select * from webcast where (wid = “& Request(“wid”) &”)”
Set rst = Server.CreateObject(“ADODB.Recordset”)
rst.Open gryWebcast, conn
If rst(“status”) = “Coming soon” Then
    u =
    t=rst (“comingsoon_text”)
    h = 0
    w = 0
    11 = “ “
    12 =“</a>”
Else
    If rst(“status”) = “Live” Then
        u = rst(“live_url”)
        t = rst(“live_text”)
        h = rst(“height”)
        w = rst(“width”)
        11 = “<a href=\’#\’ onclick=\’return fncOpen( )\’>”
        12 = “</a>”
    Else
        u = rst(“replay_url”)
        t = rst(“replay_text”)
        h = rst(“height”)
        w = rst(“width”)
        11 = “<a href=\’#\’ onclick=\”return fncOpen( )\”>”
        12 = “</a>”
    End If
End If
Response.Write(“document.write(ll + t + 12)” & vbCrLf)
Response.Write(“function fncOpen ( ) {“ & vbCrLf)
Response.Write(“var url = ‘” & u & “’ & vbCrLf)
Response.Write(var p = ‘”width=” & w & “,height=” & h & “’ &
vbCrLf)
Response.Write(“var wn = window.open(url, ‘n’, p)” & vbCrLf)
Response.Write(“return false” & vbCrLf)
Response.Write(“}”& vbCrLf)
%>
```

To use this page, a client does not create an ordinary link to “external.asp”—instead, the client can place an external JavaScript reference, for example, as:
<script language=”javascript” src=”external.asp?wid=12345”></script>

The value provided after “wid=” specifies the webcast for which the server should retrieve the desired information. The server retrieves the info, then executes the appropriate If . . . Else block, then “writes” the appropriate JavaScript code to the webpage, which the browser interprets as JavaScript (due to the “ContentType” line above), which displays and functions for the user as a link that, when clicked, shows a webcast in a window.

Various benefits of using the exemplary embodiments described herein can be realized by the client as well as the user. For example, with LaunchCode placed on a website, the client can customize features such as, for example, the appearance (color, font, etc.), working (“click here”, “join us soon”, etc.), or use a graphical link, or even no link at all (e.g., just text that says “replay coming soon”).

LaunchCode provides the client with the option of inserting a registration process into their webcast delivery. This allows the client to gather information from viewers who access their webcast. Registration can be done at any time—even after the LaunchCode is in place—at any stage in the webcast lifecycle to gather information from viewers who access their webcast. When registration is added, the client does not need to modify their LaunchCode—viewers are automatically presented with the appropriate (again, relative to the life-cycle of the webcast) registration form.

LaunchCode allows the client to have their webcast delivered in the appropriately sized frameset. Again, this option can be changed, even after the LaunchCode is in place or the user can “resize” the window that contains the frameset.

When using LaunchCode, no “programming” of the webcast is required on the part of the client. They can simply “copy and paste” a minimal and often only a single line of code on to a page on their website. Therefore, code management is nominalized. For example, in the situation of a live webcast—where the webcast might be “coming soon” for hours (or even days) in advance, broadcast live, and then posted as a replay—it is critical that visits to the client's website always see the appropriate content, based on the current stage of the webcast. Since the client does not need to maintain the “status” of the webcast, the client can focus on the content of their presentation, without having to worry about technical details.

Yet another advantage of LaunchCode is that visitors to the client's site do not “leave” the site to participate in the webcast. Because a webcast that is delivered using LaunchCode is displayed in a new window—one that is “branded” to match the look and feel of the client's website—webcast viewers will remain at the client's site once the webcast has ended.

Also, viewers arriving at a webcast that is delivered with LaunchCode have the ability to determine whether or not their computer systems are appropriately configured. Items such as web browser, bandwidth, and “plug-ins” can be checked prior to the start of the webcast, giving the viewer time to update their system, if necessary, and return to the webcast in time. Additionally, the “countdown” page that appears prior to the start of a live webcast allows the viewer to confirm that they are in the “right place,” and notifies the viewer of how long they have to wait until the live event begins. This adds to the viewer's “comfort level.”

Another advantage of using LaunchCode is for the webcast provider is that the provider has greater control over the display, functionality, and content of a webcast than one would have with an ordinary hyperlink. This control could be administrative, such as, for example, de-activating a webcast if there is an unpaid bill, or functional, such as, for example, updating the starting time for a live webcast if the event unexpectedly starts later than scheduled.

With this system, a client can place LaunchCode onto their site one time, and the appropriate link (or lack thereof) is displayed at all times. If/when any attribute of the specified webcast changes—including, but not limited to such attributes as status (live vs. on-demand), link verbiage, window size, and whether or not to utilize pre-event registration—the client does not need to update their website or modify the LaunchCode at all. Accomplishing this task is impossible without LaunchCode.

It should be appreciated that various combinations of the exemplary embodiments described above may be used to facilitate appropriate navigation of a user to a webcast event. Therefore, selected elements and features of the exemplary embodiments may be altered, added, changed, deleted, according to website design protocols or intents. Accordingly, various modifications may be made without departing from the spirit and scope of this invention.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. A method of webcasting over a communication network, comprising the steps of:
generating a client-side website code, wherein the code links to a remote webcast server having webcast content;
dynamically generating a window by executing on a client-side server, code hosted on the webcast server; and
webcasting the webcast content through the dynamically generated window.

2. The method for webcasting of claim 1, further comprising the step of:
placing the client-side website code on a client's webpage.

3. The method for webcasting of claim 1, further comprising the step of:
setting a script language setting in the client-side website code to JavaScript.

4. The method for webcasting of claim 3, wherein the step of dynamically generating a window, further comprises the step of:
invoking a non-JavaScript dynamic webpage programming script in the code hosted on the webcast server.

5. The method for webcasting of claim 4, wherein the dynamic webpage programming language is Active Server Pages.

6. The method for webcasting of claim 4, wherein the dynamic webpage programming language is Cold Fusion.

7. The method for webcasting of claim 4, wherein the dynamic webpage programming language is PHP.

8. The method for webcasting of claim 4, wherein the dynamic webpage programming language is Java.

9. The method of webcasting of claim 1, wherein the dynamically generated window contains a webcasting viewing and control window.

10. The method of webcasting of claim 1, wherein the dynamically generated window contains a viewer identification window.

11. The method of webcasting of claim 1, wherein the dynamically generated window contains a message window.

12. The method of webcasting of claim 1, wherein the dynamically generated window contains an advertisement window.

13. The method of webcasting of claim 1, further comprising the step of:
providing a status indicator prior to webcasting the webcast content.

14. The method of webcasting of claim 13, wherein the status indicator is a countdown window.

15. The method of webcasting of claim 1, further comprising the step of:
providing a viewer registration window prior to webcasting the webcast content.

16. The method of webcasting of claim 1, wherein the client-side website code has a src indicator of:
src=http://www.webcastgroup.com/launch.code?wid=idnumber, where webcastgroup.com is an variable reference to the webcast server's URL, launch.code is an variable reference to a dynamic webpage programming script, and where idnumber is variable reference to a webcast id.

17. The method of webcasting of claim 3, wherein the JavaScript is pseudo-coded as:
```
function fncOpen( ) {
    var url = “page.html”
    var name = “pagename”
    var param = “width=w, height=h, location=l, status=s”
    var w = window.open(url, name, param)
    return false
},
```
where page.html and pagename are variable names and w, h, l, s are values.

18. The method for webcasting of claim 1, wherein the webcast content is hosted remotely from the webcast server.

19. The method for webcasting of claim 1, wherein a webcast viewer's screen is on a computer.

20. The method for webcasting of claim 1, wherein a webcast viewer's screen in on a mobile phone.

21. The method for webcasting of claim 1, wherein a webcast viewer's screen is on a personal digital assistant.

22. The method for webcasting of claim 1, further comprising the step of:
tracking a viewer's characteristic with respect to the webcast.

23. The method for webcasting of claim 1, further comprising the step of:
tracking a webcast characteristic.

22. A method of webcasting over a communication network, comprising the steps of:
updating a status of a scheduled webcast on a client-side website; generating a client-side website code, wherein the code links to a remote webcast server having a content of the scheduled webcast;
dynamically generating a window by executing on a client-side server, code hosted on the webcast server; and
webcasting the webcast content through the dynamically generated window.

23. A system for webcasting over a communication network, comprising:
a server hosting a client's webpage, the server connected to a communication network;
a launchcode inserted into the client's webpage, the launchcode having a reference to a webcast server's dynamic programming script and a webcast content identifier;
a launchcode link on the client's webpage; and
a webcast server, the webcast server being connected to the communication network and having the dynamic programming script and the webcast content identified by the webcast content identifier.

24. A system for webcasting over a communication network, comprising:
an internet service provider connected to a communication network;
a server hosting a client's webpage, the server being connected to the communication network;
a launchcode inserted into the client's webpage, the launchcode having a reference to a webcast server's dynamic programming script and a webcast content identifier;
a launchcode link on the client's webpage; and
a webcast server, the webcast server being connected to the communication network and having the dynamic programming script and the webcast content identified by the webcast content identifier.
